(19) United States
(12) Patent Application Publication
(10) Pub. No.: US 2012/0105883 A1
(43) Pub. Date: May 3, 2012

(54) System and Method for Document Processing Device Cloning

(75) Inventors: Silvy J. Wilson, Santa Margarita, CA (US); Min S. Kim, Cerritos, CA (US)

(73) Assignees: Toshiba Tec Kabushiki Kaisha, Shinagawa-ku (JP); Kabushiki Kaisha Toshiba, Minato-ku (JP)

(21) Appl. No.: 12/916,428

(22) Filed: Oct. 29, 2010

(51) Int. Cl. G06F 3/12

(52) U.S. Cl. 358/1.13

(57) ABSTRACT

The subject application is directed to a system and method for cloning of document processing device configurations. The system and method include a first document processing device which has configurable components and is operable for placement in networked data communication with other document processing devices, each including an equivalent set of configurable components with the first document processing device. Registration data corresponding to an identity and address of each of the plurality of document processing devices is stored on a first document processing device. Modified configuration data corresponding to the first document processing device is received and a configuration of the configurable components of the first document processing device is updated in accordance with received modified configuration data. Modification data is communicated to each of the plurality of document processing devices corresponding to the modified configuration data in accordance with the registration data.

### BACKGROUND OF THE INVENTION

The subject application is directed generally to propagation of configuration updates from one device to one or more additional devices that share common configurable components. The application is more particularly directed to cloning configurations of document processing devices in a setting where multiple devices are connected via a data network.

Many installations of processing devices include multiple devices having the same components or a common set of components. Use of similar devices is advantageous insofar as purchases may be made in bulk, users do not have to be familiar with many types of devices, maintenance or repair is uniform, and consumables or replacement parts can be shared or distributed to different devices. One particular example of such an installation is in connection with an office or document processing environment wherein multiple document processing devices exist.

Document processing devices include printers, scanners, copiers, facsimile machines, or e-mail gateways. More recently, devices having two or more of these functions have become common, and are referred to as multifunction peripherals (MFPs) or multifunction devices (MFDs). MFPs are powerful devices, frequently containing an embedded computer, referred to as a controller. The controller functions to coordinate and control various devices or components that comprise an MFP. This includes coordinating complex sequences of individual tasks, monitoring of device status, monitoring of consumables, and the like. The controller also provides a user interface to generate a display of device state or user options, as well as to receive user instructions for performing operations on tangible or electronic documents. Many document processing devices are networked, allowing for communication between the device and workstations, servers, or other document processing devices.

Programming, configuring, or updating multiple document processing devices can be a complex and time consuming process.

### SUMMARY OF THE INVENTION

In accordance with one embodiment of the subject application, there is provided a system and method for cloning of document processing device configurations. The system and method include a first document processing device which has a plurality of configurable components and operable for placement in networked data communication with a plurality of document processing devices, each including an equivalent set of configurable components with the first document processing device. Registration data corresponding to an identity and address of each of the plurality of document processing devices is stored on a first document processing device. Modified configuration data corresponding to the first document processing device is received and a configuration of the configurable components of the first document processing device is updated in accordance with received modified configuration data. Modification data is communicated to each of the plurality of document processing devices corresponding to the modified configuration data in accordance with the registration data.

Still other advantages, aspects and features of the subject application will become readily apparent to those skilled in the art from the following description wherein there is shown and described a preferred embodiment of the subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of a system for document processing device configuration cloning according to one embodiment of the subject application;

FIG. 2 is a block diagram illustrating device hardware for use in the system for document processing device configuration cloning according to one embodiment of the subject application;

FIG. 3 is a functional diagram illustrating the device for use in the system for document processing device configuration cloning according to one embodiment of the subject application;

FIG. 4 is a block diagram illustrating controller hardware for use in the system for document processing device configuration cloning according to one embodiment of the subject application;

FIG. 5 is a functional diagram illustrating the controller for use in the system for document processing device configuration cloning according to one embodiment of the subject application;

FIG. 6 is a functional diagram illustrating a workstation for use in the system for document processing device configuration cloning according to one embodiment of the subject application;

FIG. 7 is a block diagram illustrating the system for document processing device configuration cloning according to one embodiment of the subject application;

FIG. 8 is a functional diagram illustrating the system for document processing device configuration cloning according to one embodiment of the subject application;

FIG. 9 is a flowchart illustrating a method for document processing device configuration cloning according to one embodiment of the subject application;

FIG. 10 is a flowchart illustrating a method for document processing device configuration cloning according to one embodiment of the subject application;

FIG. 11 is a diagram illustrating an example implementation of the systems and methods for document processing device configuration cloning in accordance with one embodiment of the subject application; and

FIG. 12 is a flowchart illustrating an example implementation systems and methods for document processing device configuration cloning in accordance with one embodiment of the subject application.

### DETAILED DESCRIPTION OF THE PREFERRED EMBODIMENT

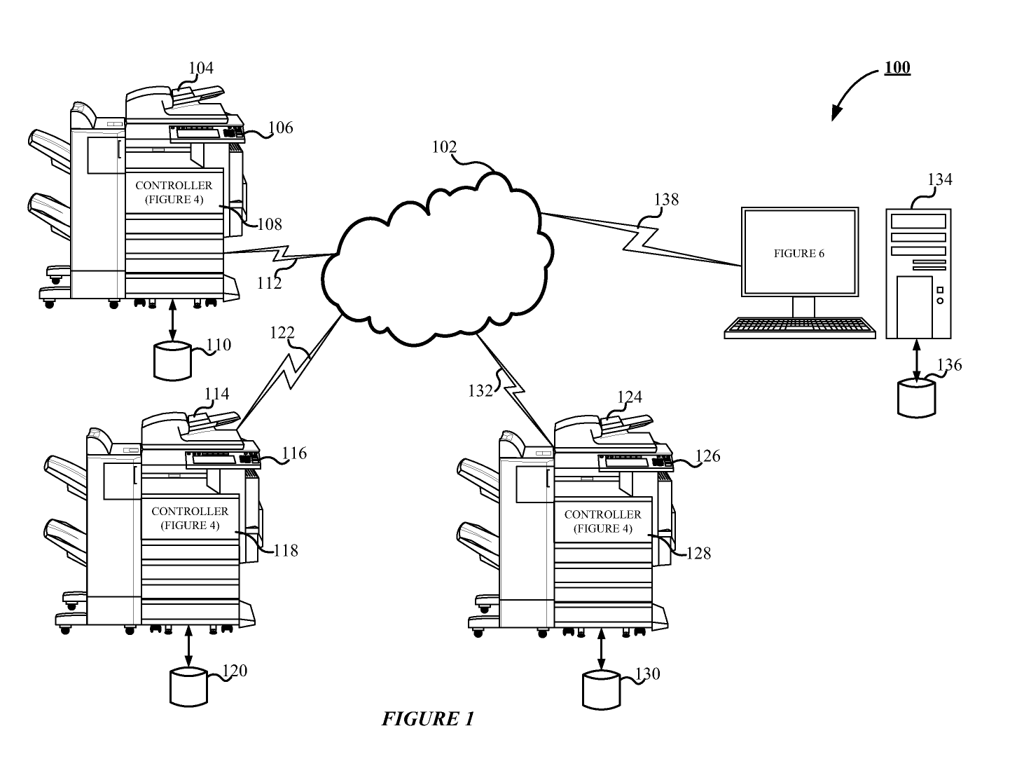

The subject application is directed to a system and method for cloning of document processing device configurations. The subject application is directed generally to propagation of configuration updates from one device to one or more additional devices that share common configurable components. The application is more particularly directed to cloning configurations of document processing devices in a setting where multiple devices are connected via a data network. It will become apparent to those skilled in the art that the system and method described herein are suitably adapted to a plurality of varying electronic fields employing automated configuration, including, for example and without limitation, communications, general computing, data processing, document processing, or the like. The preferred embodiment, as depicted in FIG. 1, illustrates a document processing field for example purposes only and is not a limitation of the subject application solely to such a field.

Referring now to FIG. 1, there is shown an overall diagram of a system 100 for cloning of document processing device configurations in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or the any suitable combination thereof. In accordance with the preferred embodiment of the subject application, the computer network 102 is comprised of physical layers and transport layers, as illustrated by the myriad conventional data transport mechanisms, such as, for example and without limitation, Token-Ring, 802.11(x), Ethernet, or other wireless or wire-based data communication mechanisms. The skilled artisan will appreciate that while a computer network 102 is shown in FIG. 1, the subject application is equally capable of use in a stand-alone system, as will be known in the art.

The system 100 also one or more document processing devices, depicted in FIG. 1 as the document processing devices 104, 114, and 124. As shown in FIG. 1, the document processing devices 104, 114, and 124 are illustrated as multifunction peripheral devices, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document processing devices include, for example and without limitation, the Toshiba e-Studio Series Controller. In accordance with one aspect of the subject application, the document processing devices 104, 114, and 124 are suitably adapted to provide remote document rendering services to external or network devices. According to one embodiment of the subject application, the document processing devices 104, 114, and 124 include hardware, software, and any suitable combination thereof, configured to interact with an associated user, a networked device, or the like. Preferably, the document processing devices 104, 114, and 124 are capable of communicating electronic documents to and from each other in accordance with user provided instructions, transferring electronic documents amongst each other based upon output capabilities, locations, or the like.

According to one embodiment of the subject application, the document processing devices 104, 114, and 124 are suitably equipped to receive a plurality of portable storage media, including, without limitation, Firewire drive, USB drive, SD, MMC, XD, Compact Flash, Memory Stick, and the like. In the preferred embodiment of the subject application, the document processing devices 104, 114, and 124 further include associated user interfaces 106, 116, and 126, such as a touch-screen, LCD display, touch-panel, alpha-numeric keypad, or the like, via which an associated user is able to interact directly with the document processing devices 104, 114, and 124. In accordance with the preferred embodiment of the subject application, the user interfaces 106, 116, and 126 are advantageously used to communicate information to associated users and receive selections from such associated users.

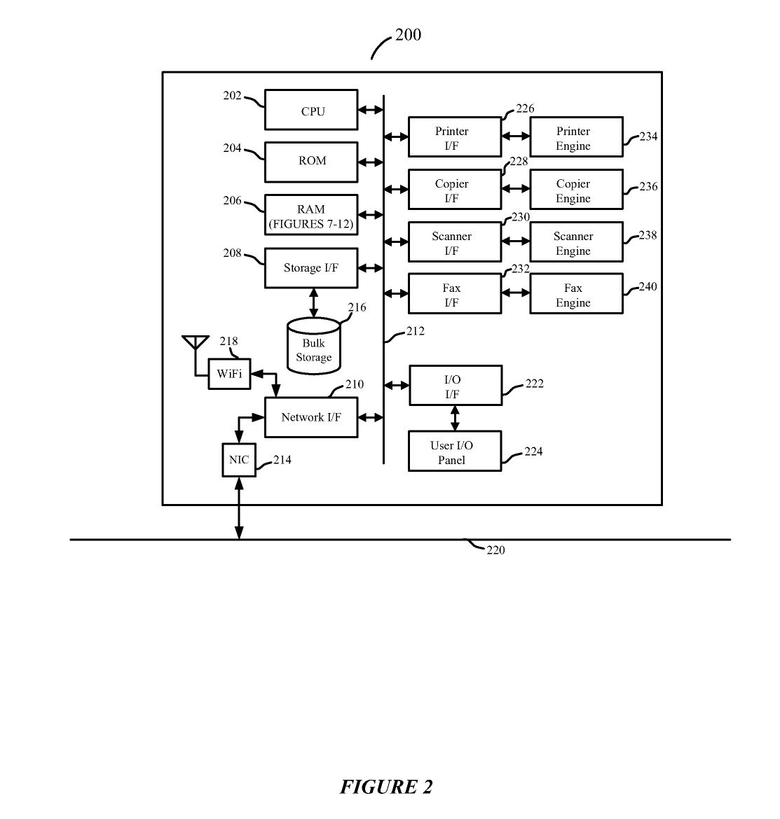

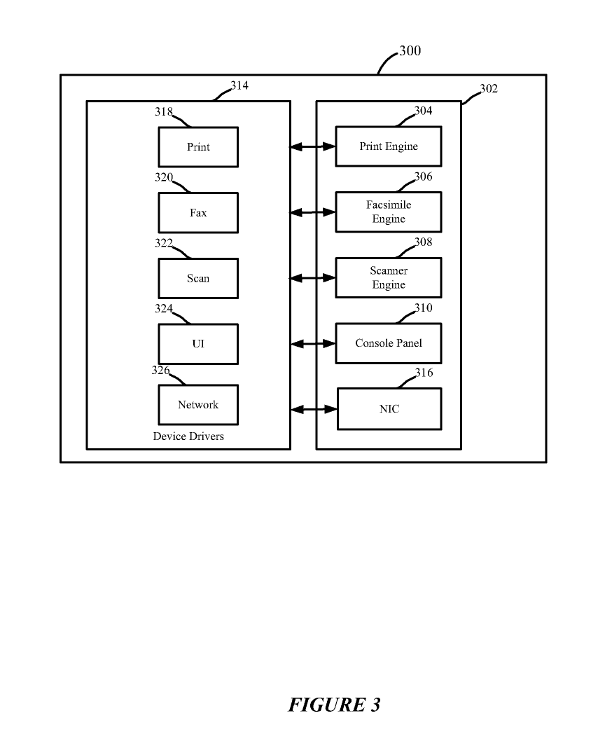

The skilled artisan will appreciate that the user interfaces 106, 116, and 126 comprise various components, suitably adapted to present data to associated users, as are known in the art. In accordance with one embodiment of the subject application, the user interfaces 106, 116, and 126 comprise a display, suitably adapted to display one or more graphical elements, text data, images, or the like, to an associated user, receive input from the associated user, and communicate the same to a backend component, such as controllers 108, 118, and 128, as explained in greater detail below. Preferably, the document processing devices 104, 114, and 124 are communicatively coupled to the computer network 102 via suitable communications links 112, 122, and 132. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art. The functioning of the document processing devices 104, 114, and 124 will be better understood in conjunction with the block diagrams illustrated in FIGS. 2 and 3, explained in greater detail below.

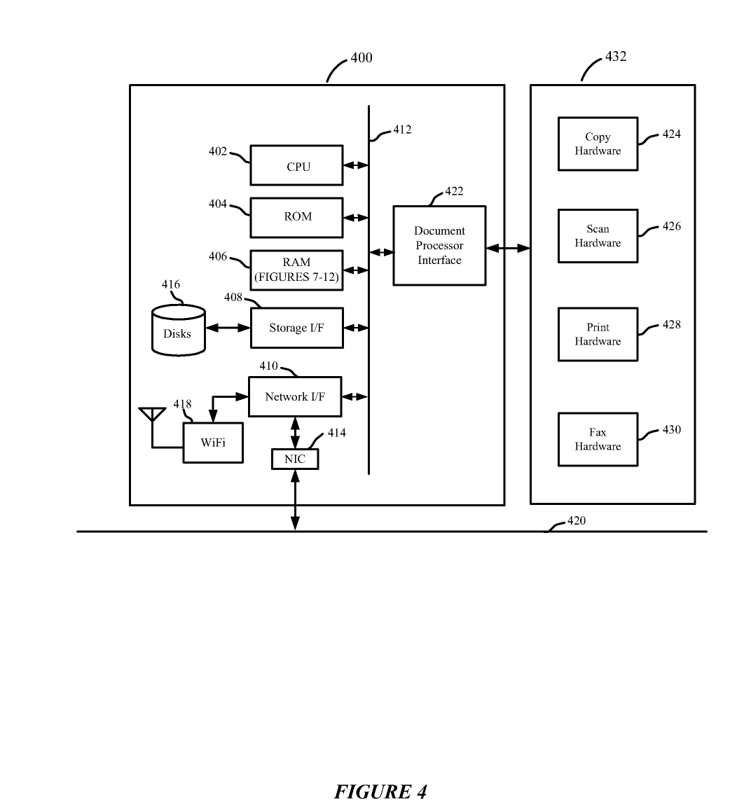

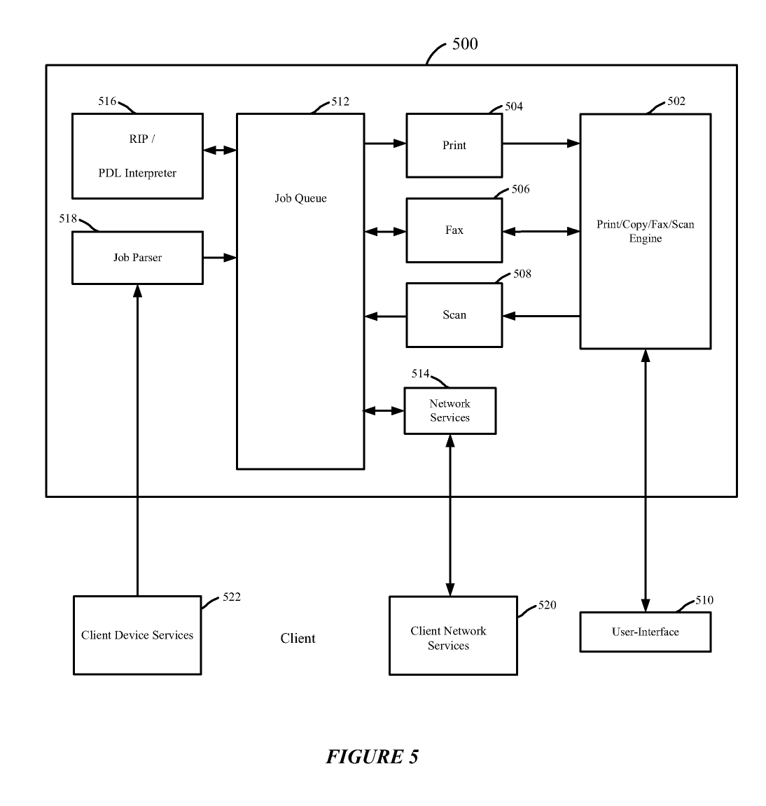

In accordance with one embodiment of the subject application, the document processing devices 104, 114, and 124 further incorporate a backend component, designated as the controllers 108, 118, and 128, suitably adapted to facilitate the operations of their respective document processing devices 104, 114, and 124, as will be understood by those skilled in the art. Preferably, the controllers 108, 118, and 128 are embodied as hardware, software, or any suitable combination thereof, configured to control the operations of the associated document processing devices 104, 114, and 124, facilitate the display of images via the user interfaces 106, 116, and 126, direct the manipulation of electronic image data, maintain the security of applications, user information, data, and the like. For purposes of explanation, the controllers 108, 118, and 128 are used to refer to any myriad of components associated with the document processing devices 104, 114, and 124, including hardware, software, or combinations thereof, functioning to perform, cause to be performed, control, or otherwise direct the methodologies described hereinafter. It will be understood by those skilled in the art that the methodologies described with respect to the controllers 108, 118, and 128 are capable of being performed by any general purpose computing system, known in the art, and thus the controllers 108, 118, and 128 are representative of such a general computing device and is intended as such when used hereinafter. Furthermore, the use of the controllers 108, 118, and 128 hereinafter is for the example embodiment only, and other embodiments, which will be apparent to one skilled in the art, are capable of employing the system and method for automated, peer-based configuration of network services of the subject application. The functioning of the controllers 108, 118, and 128 will better be understood in conjunction with the block diagrams illustrated in FIGS. 4 and 5, explained in greater detail below.

Communicatively coupled to the document processing devices 104, 114, and 124 are data storage devices 110, 120, and 130. In accordance with the preferred embodiment of the subject application, the data storage devices 110, 120, and 130 are any mass storage device known in the art including, for example and without limitation, magnetic storage drives, a hard disk drive, optical storage devices, flash memory devices, or any suitable combination thereof. In the preferred embodiment, the data storage devices 110, 120, and 130 are suitably adapted to store security levels, security software, document data, image data, electronic database data, or the like. It will be appreciated by those skilled in the art that while illustrated in FIG. 1 as being a separate component of the system 100, the data storage devices 110, 120, and 130 are capable of being implemented as internal storage components of the document processing devices 104, 114, and 124, components of the controllers 108, 118, and 128, or the like, such as, for example and without limitation, an internal hard disk drive, or the like.

Also depicted in FIG. 1 is a computer workstation 134 in data communication with the computer network 102 via a communications link 138. It will be appreciated by those skilled in the art that the workstation 134 is shown in FIG. 1 as a workstation computer for illustration purposes only. As will be understood by those skilled in the art, the workstation 134 is representative of any personal computing device known in the art including, for example and without limitation, a laptop computer, a personal computer, a personal data assistant, a web enabled cellular telephone, a smart phone, a proprietary network device, or other web-enabled electronic device. According to one embodiment of the subject application, the workstation 134 further includes software, hardware, or a suitable combination thereof configured to interact with the document processing devices 104, 114, and 124, or the like. In one embodiment of the subject application, the workstation 134 includes one or more drivers suitably configured to interact with the document processing devices 104, 114, and 124, prepare electronic documents for output thereby, and the like, as will be understood by those skilled in the art.

The communications link 138 is any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. Preferably, the workstation 134 is suitably adapted to provide document data, job data, user interface data, image data, monitor document processing jobs, employ thin-client interfaces, generate display data, generate output data, or the like, with respect to the document processing devices 104, 114, or 124, or any other similar device coupled to the computer network 102.

Communicatively coupled to the workstation 134 is the data storage device 136. According to the foregoing example embodiment, the data storage device 136 is any mass storage device, or plurality of such devices, known in the art including, for example and without limitation, magnetic storage drives, a hard disk drive, optical storage devices, flash memory devices, or any suitable combination thereof. In such an embodiment, the data storage device 136 is suitably adapted to store electronic document data, document processing device identification data, document processing device drivers, document processing device configuration data, and the like. It will be appreciated by those skilled in the art that while illustrated in FIG. 1 as being a separate component of the system 100, the data storage device 136 is capable of being implemented as an internal storage component of the workstation 134, or the like, such as, for example and without limitation, an internal hard disk drive, or the like.

Turning now to FIG. 2, illustrated is a representative architecture of a suitable device 200, shown in FIG. 1 as the document processing devices 104, 114, and 124, on which operations of the subject system are completed. Included is a processor 202, suitably comprised of a central processor unit. However, it will be appreciated that the processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the device 200.

Also included in the device 200 is random access memory 206, suitably formed of dynamic random access memory, static random access memory, or any other suitable, addressable memory system. Random access memory provides a storage area for data instructions associated with applications and data handling accomplished by the processor 202.

A storage interface 208 suitably provides a mechanism for volatile, bulk or long term storage of data associated with the device 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the device 200 to communicate to other devices. The network interface subsystem 210 suitably interfaces with one or more connections with external devices to the device 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface card 214 is interconnected for data interchange via a physical network 220, suitably comprised of a local area network, wide area network, or a combination thereof.

Data communication between the processor 202, read only memory 204, random access memory 206, storage interface 208 and the network subsystem 210 is suitably accomplished via a bus data transfer mechanism, such as illustrated by the bus 212.

Suitable executable instructions on the device 200 facilitate communication with a plurality of external devices, such as workstations, document processing devices, other servers, or the like. While, in operation, a typical device operates autonomously, it is to be appreciated that direct control by a local user is sometimes desirable, and is suitably accomplished via an optional input/output interface 222 to a user input/output panel 224 as will be appreciated by one of ordinary skill in the art.

Also in data communication with the bus 212 are interfaces to one or more document processing engines. In the illustrated embodiment, printer interface 226, copier interface 228, scanner interface 230, and facsimile interface 232 facilitate communication with printer engine 234, copier engine 236, scanner engine 238, and facsimile engine 240, respectively. It is to be appreciated that the device 200 suitably accomplishes one or more document processing functions. Systems accomplishing more than one document processing operation are commonly referred to as multifunction peripherals or multifunction devices.

Turning now to FIG. 3, illustrated is a suitable document processing device, depicted in FIG. 1 as the document processing devices 104, 114, and 124, for use in connection with the disclosed system. FIG. 3 illustrates suitable functionality of the hardware of FIG. 2 in connection with software and operating system functionality as will be appreciated by one of ordinary skill in the art. The document processing device 300 suitably includes an engine 302 which facilitates one or more document processing operations.

The document processing engine 302 suitably includes a print engine 304, facsimile engine 306, scanner engine 308 and console panel 310. The print engine 304 allows for output of physical documents representative of an electronic document communicated to the processing device 300. The facsimile engine 306 suitably communicates to or from external facsimile devices via a device, such as a fax modem.

The scanner engine 308 suitably functions to receive hard copy documents and in turn image data corresponding thereto. A suitable user interface, such as the console panel 310, suitably allows for input of instructions and display of information to an associated user. It will be appreciated that the scanner engine 308 is suitably used in connection with input of tangible documents into electronic form in bitmapped, vector, or page description language format, and is also suitably configured for optical character recognition. Tangible document scanning also suitably functions to facilitate facsimile output thereof.

In the illustration of FIG. 3, the document processing engine also comprises an interface 316 with a network via driver 326, suitably comprised of a network interface card. It will be appreciated that a network thoroughly accomplishes that interchange via any suitable physical and non-physical layer, such as wired, wireless, or optical data communication.

The document processing engine 302 is suitably in data communication with one or more device drivers 314, which device drivers allow for data interchange from the document processing engine 302 to one or more physical devices to accomplish the actual document processing operations. Such document processing operations include one or more of printing via driver 318, facsimile communication via driver 320, scanning via driver 322 and a user interface functions via driver 324. It will be appreciated that these various devices are integrated with one or more corresponding engines associated with the document processing engine 302. It is to be appreciated that any set or subset of document processing operations are contemplated herein. Document processors which include a plurality of available document processing options are referred to as multi-function peripherals.

Turning now to FIG. 4, illustrated is a representative architecture of a suitable backend component, i.e., the controller 400, shown in FIG. 1 as the controllers 108, 118, and 128, on which operations of the subject system 100 are completed. The skilled artisan will understand that the controller 400 is representative of any general computing device, known in the art, capable of facilitating the methodologies described herein. Included is a processor 402, suitably comprised of a central processor unit. However, it will be appreciated that processor 402 may advantageously be composed of multiple processors working in concert with one another as will be appreciated by one of ordinary skill in the art. Also included is a non-volatile or read only memory 404 which is advantageously used for static or fixed data or instructions, such as BIOS functions, system functions, system configuration data, and other routines or data used for operation of the controller 400.

Also included in the controller 400 is random access memory 406, suitably formed of dynamic random access memory, static random access memory, or any other suitable, addressable and writable memory system. Random access memory provides a storage area for data instructions associated with applications and data handling accomplished by processor 402.

A storage interface 408 suitably provides a mechanism for non-volatile, bulk or long term storage of data associated with the controller 400. The storage interface 408 suitably uses bulk storage, such as any suitable addressable or serial storage, such as a disk, optical, tape drive and the like as shown as 416, as well as any suitable storage medium as will be appreciated by one of ordinary skill in the art.

A network interface subsystem 410 suitably routes input and output from an associated network allowing the controller 400 to communicate to other devices. The network interface subsystem 410 suitably interfaces with one or more connections with external devices to the device 400. By way of example, illustrated is at least one network interface card 414 for data communication with fixed or wired networks, such as Ethernet, token ring, and the like, and a wireless interface 418, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 414 is interconnected for data interchange via a physical network 420, suitably comprised of a local area network, wide area network, or a combination thereof.

Data communication between the processor 402, read only memory 404, random access memory 406, storage interface 408 and the network interface subsystem 410 is suitably accomplished via a bus data transfer mechanism, such as illustrated by bus 412.

Also in data communication with the bus 412 is a document processor interface 422. The document processor interface 422 suitably provides connection with hardware 432 to perform one or more document processing operations. Such operations include copying accomplished via copy hardware 424, scanning accomplished via scan hardware 426, printing accomplished via print hardware 428, and facsimile communication accomplished via facsimile hardware 430. It is to be appreciated that the controller 400 suitably operates any or all of the aforementioned document processing operations. Systems accomplishing more than one document processing operation are commonly referred to as multifunction peripherals or multifunction devices.

Functionality of the subject system 100 is accomplished on a suitable document processing device, such as the document processing device 104, which includes the controller 400 of FIG. 4, (shown in FIG. 1 as the controllers 108, 118, and 128) as an intelligent subsystem associated with a document processing device. In the illustration of FIG. 5, controller function 500 in the preferred embodiment, includes a document processing engine 502. A suitable controller functionality is that incorporated into the Toshiba e-Studio system in the preferred embodiment. FIG. 5 illustrates suitable functionality of the hardware of FIG. 4 in connection with software and operating system functionality as will be appreciated by one of ordinary skill in the art.

In the preferred embodiment, the engine 502 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document processing devices that perform one or more of the document processing operations listed above.

The engine 502 is suitably interfaced to a user interface panel 510, which panel allows for a user or administrator to access functionality controlled by the engine 502. Access is suitably enabled via an interface local to the controller, or remotely via a remote thin or thick client.

The engine 502 is in data communication with the print function 504, facsimile function 506, and scan function 508. These functions facilitate the actual operation of printing, facsimile transmission and reception, and document scanning for use in securing document images for copying or generating electronic versions.

A job queue 512 is suitably in data communication with the print function 504, facsimile function 506, and scan function 508. It will be appreciated that various image forms, such as bit map, page description language or vector format, and the like, are suitably relayed from the scan function 308 for subsequent handling via the job queue 512.

The job queue 512 is also in data communication with network services 514. In a preferred embodiment, job control, status data, or electronic document data is exchanged between the job queue 512 and the network services 514. Thus, suitable interface is provided for network based access to the controller function 500 via client side network services 520, which is any suitable thin or thick client. In the preferred embodiment, the web services access is suitably accomplished via a hypertext transfer protocol, file transfer protocol, uniform data diagram protocol, or any other suitable exchange mechanism. The network services 514 also advantageously supplies data interchange with client side services 520 for communication via FTP, electronic mail, TELNET, or the like. Thus, the controller function 500 facilitates output or receipt of electronic document and user information via various network access mechanisms.

The job queue 512 is also advantageously placed in data communication with an image processor 516. The image processor 516 is suitably a raster image process, page description language interpreter or any suitable mechanism for interchange of an electronic document to a format better suited for interchange with device functions such as print 504, facsimile 506 or scan 508.

Finally, the job queue 512 is in data communication with a parser 518, which parser suitably functions to receive print job language files from an external device, such as client device services 522. The client device services 522 suitably include printing, facsimile transmission, or other suitable input of an electronic document for which handling by the controller function 500 is advantageous. The parser 518 functions to interpret a received electronic document file and relay it to the job queue 512 for handling in connection with the afore-described functionality and components.

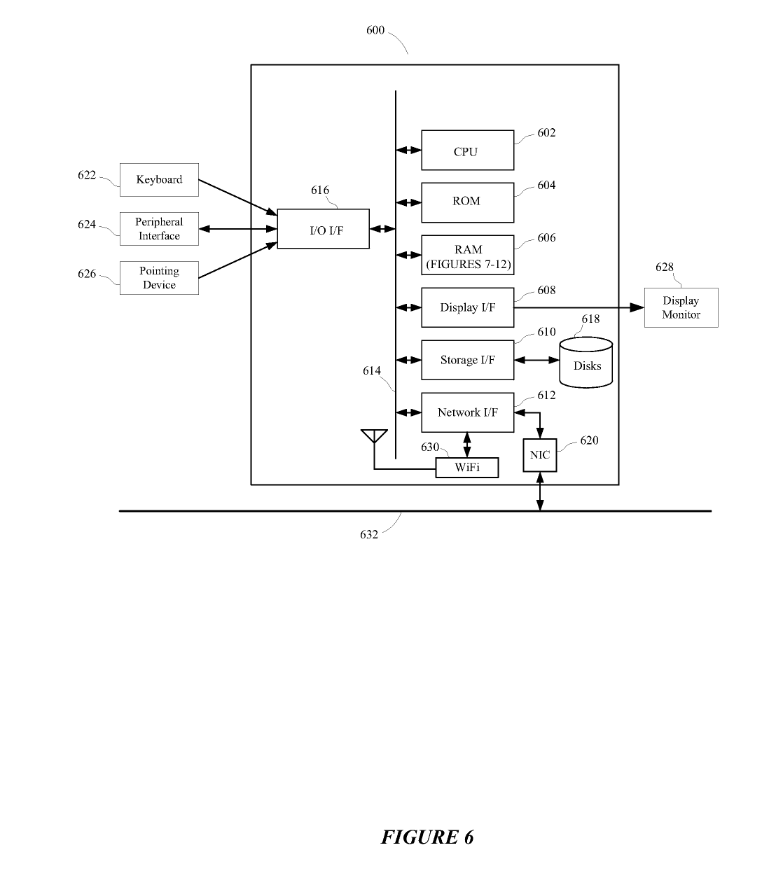

Turning now to FIG. 6, illustrated is a hardware diagram of a suitable workstation 600, shown as the computer workstation 134, for use in connection with the subject system. A suitable workstation includes a processor unit 602 which is advantageously placed in data communication with read only memory 604, suitably non-volatile read only memory, volatile read only memory or a combination thereof, random access memory 606, display interface 608, storage interface 610, and network interface 612. In a preferred embodiment, interface to the foregoing modules is suitably accomplished via a bus 614.

The read only memory 604 suitably includes firmware, such as static data or fixed instructions, such as BIOS, system functions, configuration data, and other routines used for operation of the workstation 600 via CPU 602.

The random access memory 606 provides a storage area for data and instructions associated with applications and data handling accomplished by the processor 602.

The display interface 608 receives data or instructions from other components on the bus 614, which data is specific to generating a display to facilitate a user interface. The display interface 608 suitably provides output to a display terminal 628, suitably a video display device such as a monitor, LCD, plasma, or any other suitable visual output device as will be appreciated by one of ordinary skill in the art.

The storage interface 610 suitably provides a mechanism for non-volatile, bulk or long term storage of data or instructions in the workstation 600. The storage interface 610 suitably uses a storage mechanism, such as storage 618, suitably comprised of a disk, tape, CD, DVD, or other relatively higher capacity addressable or serial storage medium.

The network interface 612 suitably communicates to at least one other network interface, shown as network interface 620, such as a network interface card, and wireless network interface 630, such as a WiFi wireless network card. It will be appreciated that by one of ordinary skill in the art that a suitable network interface is comprised of both physical and protocol layers and is suitably any wired system, such as Ethernet, token ring, or any other wide area or local area network communication system, or wireless system, such as WiFi, WiMax, or any other suitable wireless network system, as will be appreciated by one of ordinary skill in the art. In the illustration, the network interface 620 is interconnected for data interchange via a physical network 632, suitably comprised of a local area network, wide area network, or a combination thereof.

An input/output interface 616 in data communication with the bus 614 is suitably connected with an input device 622, such as a keyboard or the like. The input/output interface 616 also suitably provides data output to a peripheral interface 624, such as a USB, universal serial bus output, SCSI, Firewire (IEEE 1394) output, or any other interface as may be appropriate for a selected application. Finally, the input/output interface 616 is suitably in data communication with a pointing device interface 626 for connection with devices, such as a mouse, light pen, touch screen, or the like.

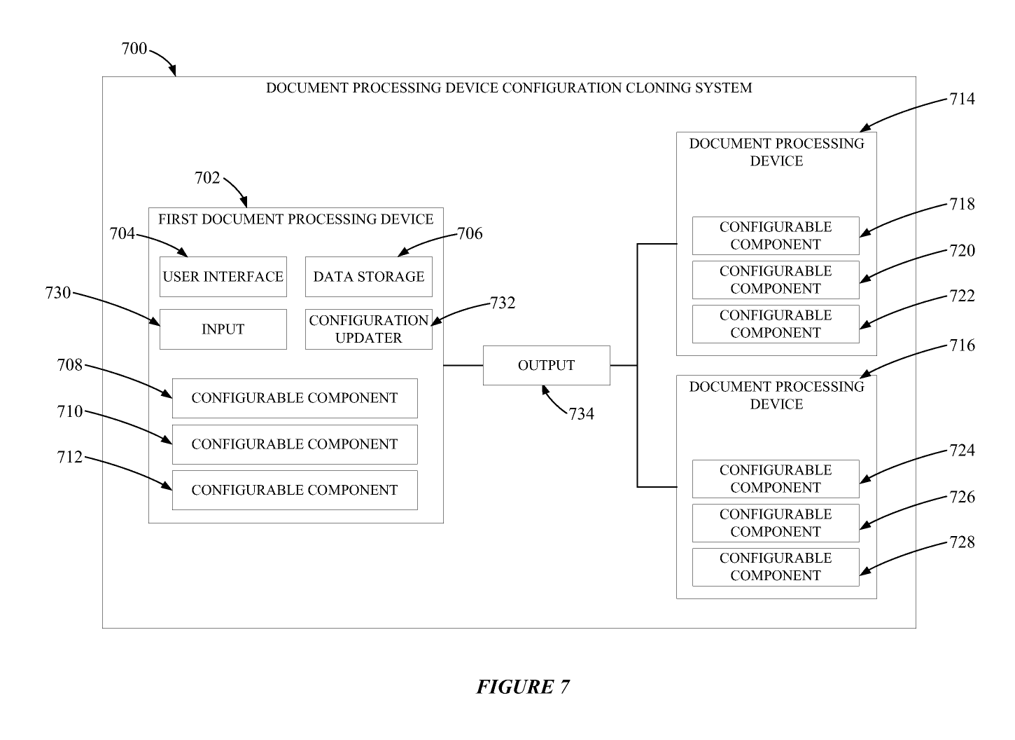

Referring now to FIG. 7, illustrated is a block diagram of a secure device configuration cloning system 700 in accordance with one embodiment of the subject application. As shown in FIG. 7, the document processing device configuration cloning system 700 includes a first document processing device 702 that is equipped with a user interface 704, a data storage 706, and one or more configurable components 708-712. Preferably, the first document processing device 702 is configured for placement in networked data communication with a plurality of document processing devices 714, 716. According to one embodiment of the subject application, each of the other document processing devices 714, 716 includes an equivalent set of configurable components 718-722 and 724-728 with the first document processing device 702.

The data storage 706 on the first document processing device 702 includes registration data that corresponds to the identity and address of each of the other document processing devices 714 and 716. The system 700 further includes an input 730 that is associated with the user interface 704 and is configured to receive modified configuration data that corresponds to the first document processing device 702.

A configuration update 732 is also employed by the system 700, which is operable to update the configuration of the configurable components 708-712 of the first document processing device 702 based upon the received modified configuration data. The system 700 further includes an output 734 that is configured to communicate the modification data to each of other document processing devices 714 and 716, i.e. communicate the modified configuration data based upon the registration data.

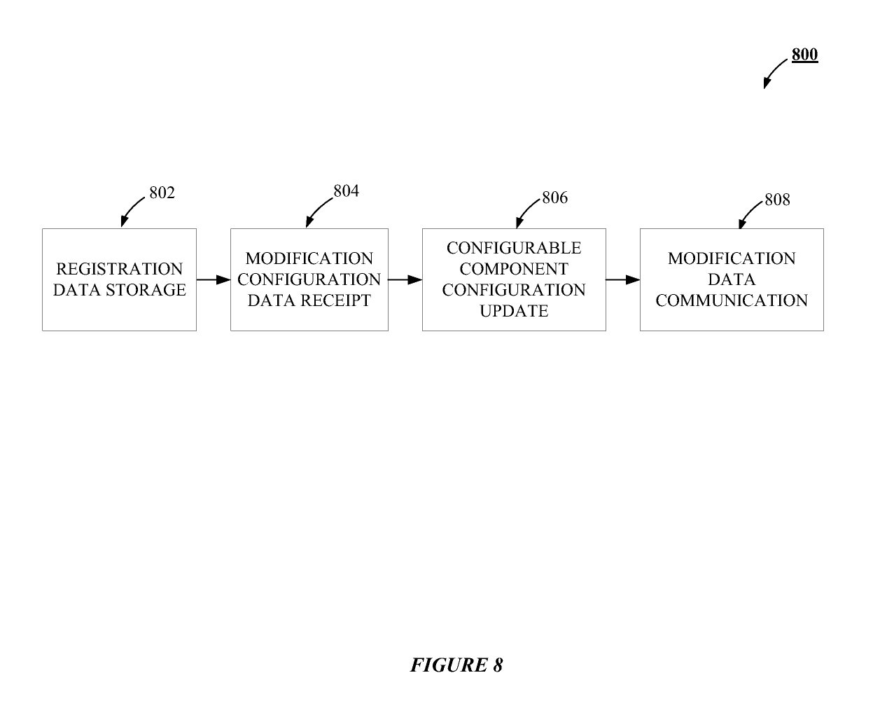

Turning now to FIG. 8, illustrated is a functional diagram of a system for document processing device cloning in accordance with one embodiment of the subject application. As shown in FIG. 8, registration data storage 802 is first performed by a first document processing device of registration data representing the identity and address of multiple other document processing devices. Preferably, the first document processing device is operable for placement in networked communication with the other document processing devices. According to one embodiment of the subject application, the first document processing device includes a set of configurable components, while similarly each other document processing device includes a corresponding set of configurable components.

Modification configuration data receipt 804 then occurs of modified configuration data corresponding to the first document processing device. Configurable component configuration update 806 is then performed of the configurable components of the first document processing device based upon the received configuration data. Modification data communication 808 then occurs of the modification data to each of the other document processing devices from the first document processing device based upon the stored registration data.

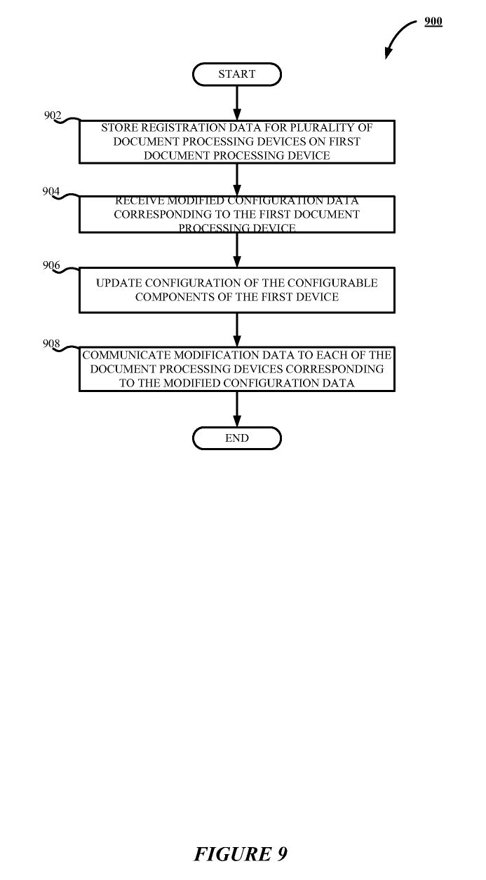

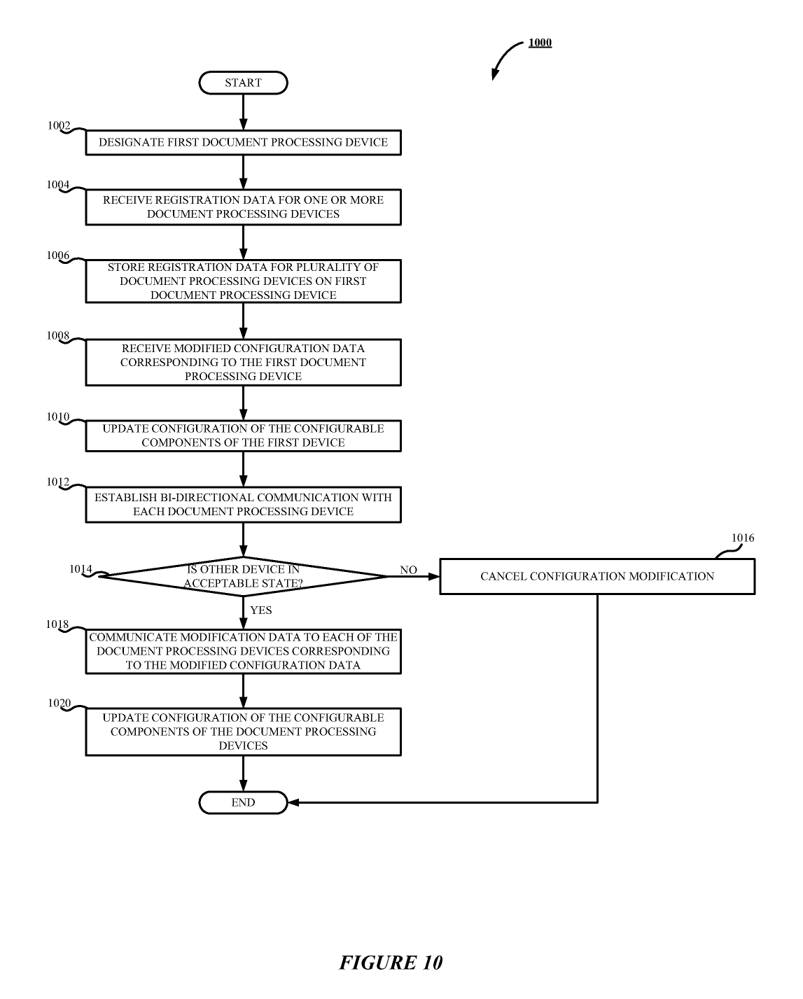

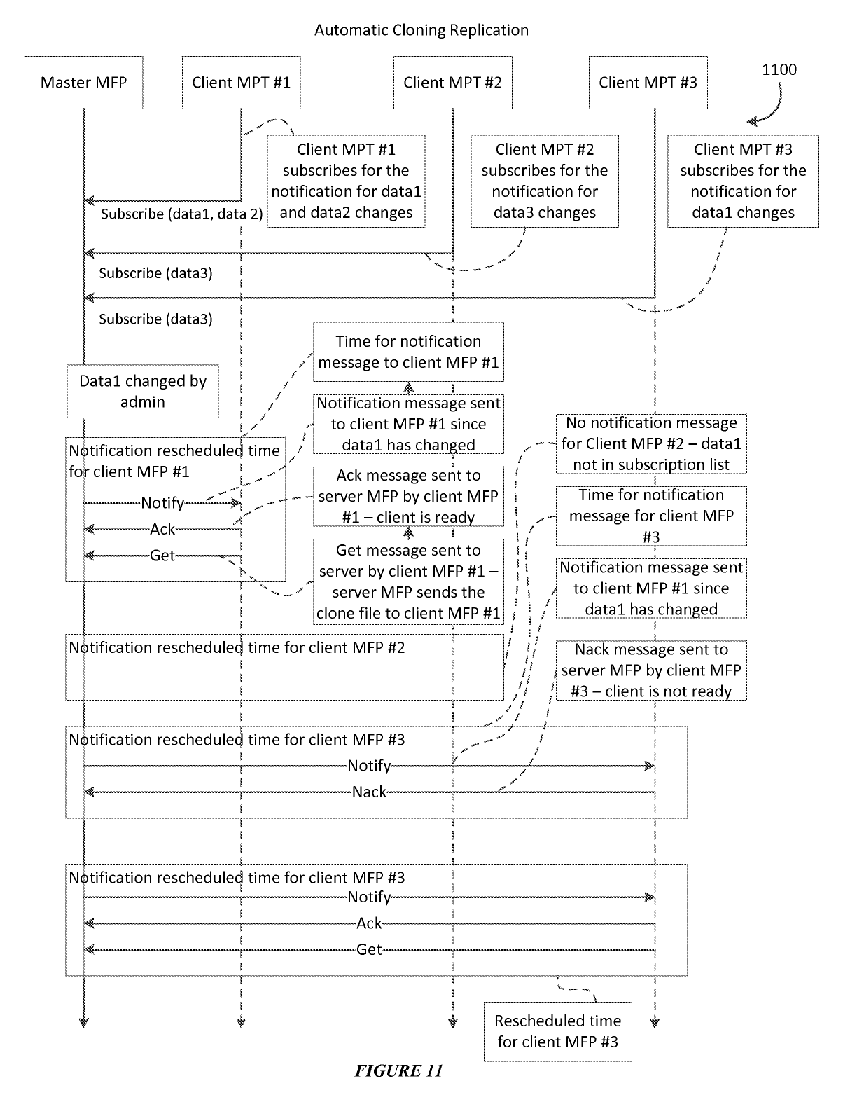

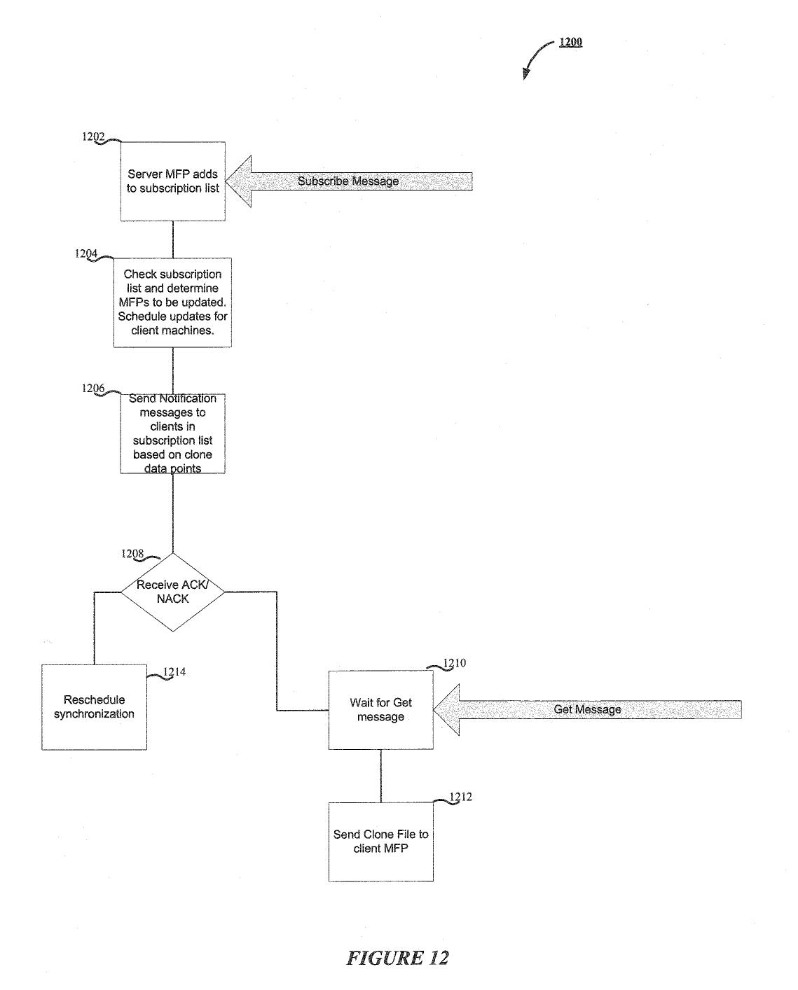

The skilled artisan will appreciate that the subject system 100 and components described above with respect to FIG. 1, FIG. 2, FIG. 3, FIG. 4, FIG. 5, FIG. 6, FIG. 7, and FIG. 8 will be better understood in conjunction with the methodologies described hereinafter with respect to FIG. 9 and FIG. 10, as well as the example implementations of FIGS. 11 and 12. Turning now to FIG. 9, there is shown a flowchart 900 illustrating a document processing device configuration cloning method in accordance with one embodiment of the subject application. Beginning at step 902, registration data is stored on a data storage of a first document processing device. The registration data corresponds to the identity and address of each of a plurality of document processing devices. Preferably, the first document processing device includes a plurality of configurable components and is operable for placement in networked data communication with the plurality of document processing devices. According to one embodiment of the subject application, each of the plurality of document processing devices includes an equivalent set of configurable components with the first document processing device.

At step 904, modified configuration data is received corresponding to the first document processing device. A configuration of the configurable components of the first document processing device is then updated at step 906 in accordance with the received modified configuration data. Thereafter, at step 908, modification data is communicated to each of the plurality of document processing devices corresponding to the modified configuration data in accordance with the registration data.

Referring now to FIG. 10, there is shown a flowchart 1000 illustrating a document processing device configuration cloning method in accordance with one embodiment of the subject application. The methodology of FIG. 10 begins at step 1002, whereupon a first document processing device is designated by an administrator, either directly via an associated user interface, via the user device 134, or the like. For example purposes only, reference is made herein to the first document processing device as the document processing device 104. As illustrated in FIG. 1, the first document processing device 104 includes a user interface 106 and an associated data storage 110. Preferably, the first document processing device 104 further includes a plurality of configurable components, which include, for example and without limitation, address books, user lists, network settings, device usage restrictions, device configuration settings, and the like.

At step 1004, registration data is received by the first document processing device 104 of the identity and address of subscribing document processing devices 114 and 124. Preferably, this registration data includes the identification (ID) of the document processing devices 114 and 124, the network address (IP address, MAC address, or the like), clone data pointer data to configurable components associated with each respective document processing device 114 and 124, as well as any other suitable identifying indicia. At step 1006, the received registration data is stored on the first document processing device 104 corresponding to the identity and address of each other document processing device 114 and 124 that is configured to receive configuration updates. Thus, at step 1006, registration data for the second document processing device 114 and the third document processing device 124 is stored on the data storage 110 of the first document processing device 104.

The first document processing device 104 then receives modified configuration data at step 1008 via the user interface 106, electronically from the user device 134, or other suitable means. One or more configurable components of the first document processing device 104 are then updated with the received modification data at step 1010. Preferably, the controller 108 or other suitable component associated with the first document processing device 104 implements the configuration modifications input by the user, administrator, or the like. A bi-directional communication channel is then established with the other document processing devices 114 and 124 via the computer network 102 at step 1012. FIG. 11 illustrates a suitable example 1100 the communications between the first document processing device 104, and the other document processing devices 114 and 124 in accordance with one example embodiment of the subject application.

A determination is then made at step 1014 whether the second document processing device 114 and/or the third document processing device 124 are in acceptable states for configuration updates. That is, whether the document processing device 114 and/or 124 are in a maintenance state, e.g. suspended from user operations during configuration updates, or other such operation state. In the event that one of the document processing devices 114 or 124 is unable to communicate, flow proceeds to step 1016, whereupon the modification data is not communicated to the corresponding device 114 or 124 and operations with respect to that device 114 or 124 and FIG. 10 terminate.

Upon a positive determination at step 1014, operations proceed to step 1018, whereupon modification data is communicated to each document processing device 114 and/or 124 determined to be in an acceptable state. Preferably, the modification data is communicated to each document processing device 114 and/or 124 based upon the clone data pointer to the respective configurable components. At step 1020, each receiving document processing device 114 and 124 updates the configurable components with the modification data based upon the clone pointer data associated therewith. Operations with respect to FIG. 10 terminate thereafter.

In accordance with one example embodiment of the subject application, the first document processing device 104, i.e. the master document processing device, operates a server program configured to manage client subscription, notification, scheduling, clone file creation, and file communication to client document processing devices 114 and 124. The client document processing devices 114 and 124 run a client program which handles listening for notification updates from the master document processing device 104, receiving the clone file, and installing the clone data in the clone file.

The cloning replication protocol is used for communication between the master document processing device 104 and the client document processing devices 114 and 124. During the automatic synchronization process, the master document processing device 104 and the client document processing devices 114 and 124 that is being synchronized must be in maintenance mode. The maintenance mode means that no other operations are allowed on the client document processing devices 114 and 124. As a result of this unavailability during the automatic cloning replication, the master document processing device 104 has a scheduling component that is configured to select one client document processing device 114 or 124 for each default wait time.

The automatic synchronization protocol as set forth by the systems and methods described above is configured for supporting six distinct message types, Subscribe, Notify, Ack, Nack, Get, and Unsubscribe. According to one embodiment of the subject application, the Subscribe message is sent by the client document processing devices 114 and 124 to the master document processing device 104 to be added to the list of document processing devices to be updated. The message contains the list of clone pointers. For example, a document processing device is capable of only requiring device settings updates, and not internal address book updates, or the like. The Notify message is sent by the master document processing device 104 to the client document processing devices 114 and 124 with a subscription list that contains changes on the master document processing device 104.

The Ack message is sent by the client document processing devices 114 and 124 to the master document processing device 104 indicating that the client document processing devices 114 and 124 are ready to receive the clone file. The Nack message sent by the client document processing devices 114 and 124 to the master document processing device 104 indicating that the client document processing device 114 or 124 is not ready to receive the clone file. The master document processing device 104 then reschedules the cloning replication for this particular client document processing device 114 or 124 upon receipt. The Get message sent by the client document processing devices 114 and 124 to the master document processing device 104 for the clone file. The Unsubscribe message is sent by the client document processing devices 114 and 124 to the master document processing device 104 to unsubscribe from the list, i.e. upon a determination that synchronization is no longer desired.

In operation, as illustrated by the flowchart 1200 of FIG. 12, the client document processing devices 114 and 124 send Subscribe messages with the selected list of clone data types to the master document processing device 104. At step 1202, the server program operative on the master document processing device 104 saves the client subscription list for each client document processing device 114 and 124. The administrator then makes any desired changes on the configuration settings on the master document processing device 104. At step 1204, the server program on the master document processing device 104 detects the changes and starts the notification process based on the scheduling algorithm. The scheduling algorithm defines default wait time, sends the notification to each client document processing device 114 and 124 after a wait time in round robin scheduling. The notification is only sent if the changes are in the client subscription list. At step 1208 a determination is made whether an Ack or a Nack message has been received from the client document processing device 114 or 124. If the client document processing device 114 or 124 sends an Ack message, the master document processing device 104 will wait for the Get message from the client document processing device 114 or 124 at step 1210. When the master document processing device receives the Get message from the client document processing device 114 or 124, the master document processing device 104 sends the clone file to the client document processing device 114 or 124 at step 1212. The client application then applies the clone file to the client document processing device 114 or 124. This completes the cloning replication for this client document processing device 114 or 124.

Upon a determination that the client document processing device 114 or 124 has sent a Nack message, the master document processing device 104 reschedules the clone replication for this client document processing device 114 or 124 at step 1214 and sends the notification again at the rescheduled time. Preferably, the master document processing device 104 repeats this process until all client document processing devices 114 and 124 install the clone data.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A document processing device configuration cloning system comprising:
a first document processing device having a user interface, a data storage, and plurality of configurable components, and operable for placement in networked data communication with a plurality of document processing devices, each including an equivalent set of configurable components with the first document processing device;
the data storage on the first document processing device including registration data corresponding to an identity and address of each of the plurality of document processing devices;
an input associated with the user interface operable to receive modified configuration data corresponding to the first document processing device;
a configuration updater operable to update a configuration of the configurable components of the first document processing device in accordance with received modified configuration data; and
an output operable to communicate modification data to each of the plurality of document processing devices corresponding to the modified configuration data in accordance with the registration data.

2. The system of claim 1 further comprising an input operable to receive registration data into the data storage for at least one additional document processing device such that the at least one additional document processing device is registered to receive the modified configuration data.

3. The system of claim 1 wherein the registration data further includes clone data pointer data for each of the plurality of document processing devices, which clone data pointer data is representative of a corresponding equivalent set of configurable components of each respective document processing device of the plurality thereof relative to the first document processing device, and wherein modification data is communicated to each of the plurality of document processing devices in accordance with clone data pointer data associated with each destination device.

4. The system of claim 1 further comprising:
a synchronizer associated with the first document processing device operative to establish bidirectional communication with each document processing device of the plurality thereof prior to communication of the modified configuration data thereto.

5. The system of claim 4 further wherein the synchronizer is further operable to selectively communicate modified configuration data with each document processing device of the plurality thereof in accordance with the bidirectional communication there between indicative of an acceptable device update state.

6. The system of claim 5 wherein the bidirectional communication indicative of an acceptable device update state corresponds to a device being placed in a maintenance mode.

7. The system of claim 6 wherein the maintenance mode corresponds to a suspension of the device for user operation during a configuration update.

8. A document processing device configuration cloning method comprising:
storing, on a data storage of a first document processing device, registration data corresponding to an identity and address of each of a plurality of document processing devices, the first document processing device having a plurality of configurable components and operable for placement in networked data communication with the plurality of document processing devices, each including an equivalent set of configurable components with the first document processing device;
receiving modified configuration data corresponding to the first document processing device;
updating a configuration of the configurable components of the first document processing device in accordance with received modified configuration data; and
communicating modification data to each of the plurality of document processing devices corresponding to the modified configuration data in accordance with the registration data.

9. The method of claim 8 further comprising receiving registration data into the data storage for at least one additional document processing device such that the at least one additional document processing device is registered to receive the modified configuration data.

10. The method of claim 8 wherein the registration data further includes clone data pointer data for each of the plurality of document processing devices, which clone data pointer data is representative of a corresponding equivalent set of configurable components of each respective document processing device of the plurality thereof relative to the first document processing device, and wherein modification data is communicated to each of the plurality of document processing devices in accordance with clone data pointer data associated with each destination device.

11. The method of claim 8 further comprising establishing bidirectional communication with each document processing device of the plurality thereof prior to communication of the modified configuration data thereto.

12. The method of claim 11 further comprising selectively communicating modified configuration data with each document processing device of the plurality thereof in accordance with the bidirectional communication there between indicative of an acceptable device update state.

13. The method of claim 12 wherein the bidirectional communication indicative of an acceptable device update state corresponds to a device being placed in a maintenance mode.

14. The method of claim 13 wherein the maintenance mode corresponds to a suspension of the device for user operation during a configuration update.

15. A document processing device configuration cloning system comprising:
means adapted for storing, on a data storage of a first document processing device, registration data corresponding to an identity and address of each of a plurality of document processing devices, the first document processing device having a plurality of configurable components and operable for placement in networked data communication with the plurality of document processing devices, each including an equivalent set of configurable components with the first document processing device;
means adapted for receiving modified configuration data corresponding to the first document processing device;
means adapted for updating a configuration of the configurable components of the first document processing device in accordance with received modified configuration data; and
means adapted for communicating modification data to each of the plurality of document processing devices corresponding to the modified configuration data in accordance with the registration data.

16. The system of claim 15 further comprising means adapted for receiving registration data into the data storage for at least one additional document processing device such that the at least one additional document processing device is registered to receive the modified configuration data.

17. The system of claim 15 wherein the registration data further includes clone data pointer data for each of the plurality of document processing devices, which clone data pointer data is representative of a corresponding equivalent set of configurable components of each respective document processing device of the plurality thereof relative to the first document processing device, and wherein modification data is communicated to each of the plurality of document processing devices in accordance with clone data pointer data associated with each destination device.

18. The system of claim 15 further comprising means adapted for establishing bidirectional communication with each document processing device of the plurality thereof prior to communication of the modified configuration data thereto.

19. The system of claim 18 further means adapted for comprising selectively communicating modified configuration data with each document processing device of the plurality thereof in accordance with the bidirectional communication there between indicative of an acceptable device update state.

20. The system of claim 19 wherein the bidirectional communication indicative of an acceptable device update state corresponds to a device being placed in a maintenance mode.

21. The system of claim 21 wherein the maintenance mode corresponds to a suspension of the device for user operation during a configuration update.
